(19) United States
(12) Patent Application Publication
(10) Pub. No.: US 2025/0390107 A1
(43) Pub. Date: Dec. 25, 2025

(54) ROBOT SYSTEM AND METHOD FOR TRANSPORTING WORKPIECE USING TRANSPORT ROBOT

(71) Applicant: KAWASAKI JUKOGYO KABUSHIKI KAISHA, Kobe-shi (JP)

(72) Inventors: Yoshitaka MURAMATSU, Kobe-shi (JP); Shogo FUJITA, Kobe-shi (JP); Kento YOSHINOBU, Kobe-shi (JP)

(73) Assignee: KAWASAKI JUKOGYO KABUSHIKI KAISHA, Kobe-shi (JP)

(21) Appl. No.: 19/241,122

(22) Filed: Jun. 17, 2025

(30) Foreign Application Priority Data
Jun. 21, 2024 (JP) 2024-100479

(51) Int. Cl. G05D 1/646

(52) U.S. Cl. CPC G05D 1/646

(57) ABSTRACT

A robot system includes: a robot placed in a work area; and a transport robot that transports a workpiece to the work area by autonomously traveling while estimating its own position using a map and a sensor and stops in the work area; and an object located between the robot and the transport robot in the work area, the object being detected by the sensor and included as a wall in the map both when the transport robot creates the map using the sensor and when the transport robot transports the workpiece using the map and the sensor.

### CROSS-REFERENCE TO RELATED APPLICATION

This application claims priority to Japanese Patent Application No. 2024-100479 filed on Jun. 21, 2024, the entire disclosure of which is incorporated herein by reference.

### BACKGROUND

The technology disclosed herein relates to a robot system and a method for transporting a workpiece using a transport robot.

A conventional robot system used in the assembly line for automobile bodies includes multi-axis robots. The multi-axis robots are used to weld bodies, for example. The conventional robot system further includes, for example, an automatic guided vehicle (AGV). The AGV carries a body to an assembly area by traveling along a magnetic tape on a floor surface.

### SUMMARY

An autonomous mobile robot (AMR) may transport the workpiece in place of the AGV. The AMR has a simultaneous localization and mapping (SLAM) function. The SLAM function enables the AMR to travel autonomously using maps and sensors. Use of the AMR no longer requires the magnetic tape on the floor surface.

The AMR creates maps. The AMR creates a map by detecting walls by using the sensors while traveling in a factory building. Here, the walls mean objects indicating boundaries of an area where the AMR can travel on the map. The walls are not limited to walls as a structure of a building. The AMR transporting the workpiece estimates its own position by collating the positions of the walls detected by the sensors with the map.

In many cases, a robot that works on a workpiece is placed inside the building when the AMR creates the map. However, the sensors of the AMR do not always detect the robot as the wall during the map creation; thus, the robot is not always included in the map. In addition, the robot moves while working on the workpiece. Thus, even if the robot is included as the wall in the map, the position of the robot may differ between the position detected by the sensors of the AMR and the position in the map. The robot itself is less likely to be used for the localization of the AMR.

On the other hand, the sensors of the AMR may fail to detect the wall included in the map or may have difficulty in detecting the wall while the AMR transports the workpiece, due to interference of the robot placed in the work area. If the sensors cannot detect the wall, the localization of the AMR may decrease in accuracy. The AMR is particularly required to stop at a precise position in the work area, because the workpiece is required to be at the correct position with respect to the robot in the work area. High accuracy is required for the localization of the AMR in the work area. However, there are multiple robots in the work area, making it more difficult for the sensors of the AMR to detect the wall.

The technology disclosed herein relates to a robot system. The robot system includes:
a robot placed in a work area where work is performed on a workpiece;
a transport robot that includes: a map of a specific area including the work area; and a sensor that detects surrounding conditions, the transport robot transporting the workpiece to the work area by autonomously traveling in the specific area while estimating its own position using the map and the sensor and stopping in the work area until the work on the workpiece is finished; and
an object located between the robot and the transport robot in the work area, the object being detected by the sensor and included as a wall in the map both when the transport robot creates the map of the specific area using the sensor and when the transport robot transports the workpiece using the map and the sensor.

### BRIEF DESCRIPTION OF THE DRAWINGS

FIG. 1 is a diagram illustrating part of an automobile manufacturing factory where a robot system is constructed.

FIG. 2 is a perspective view of a work area.

FIG. 3 is a rear view of the work area.

FIG. 4 is a block diagram of the robot system.

FIG. 5 is a block diagram of an AMR.

FIG. 6 is a perspective view of a locator with a first object.

FIG. 7 is a perspective view of a locator with a second object.

FIG. 8 is a plan view illustrating objects arranged in a first work area and objects arranged in a second work area.

FIG. 9 is a flowchart of the control of an AMR.

### DETAILED DESCRIPTION OF THE DRAWINGS

Embodiments of a robot system and a method for transporting a workpiece using a robot will be described with reference to the drawings. The robot system and the transport method described herein are merely examples.

### (Overall Structure of Robot System)

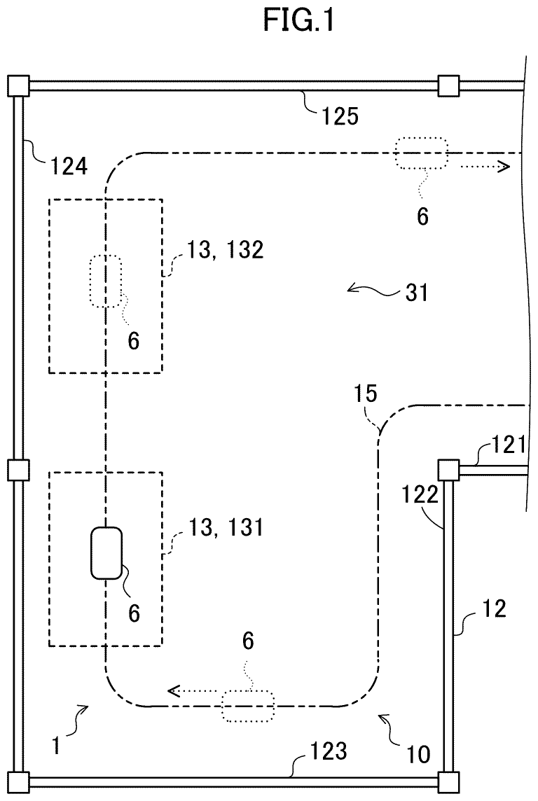

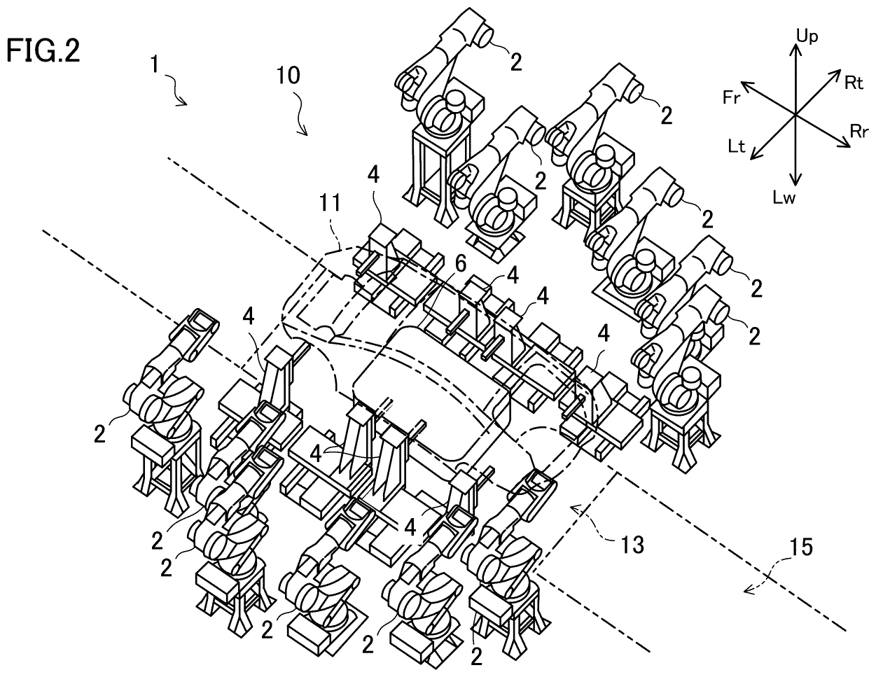

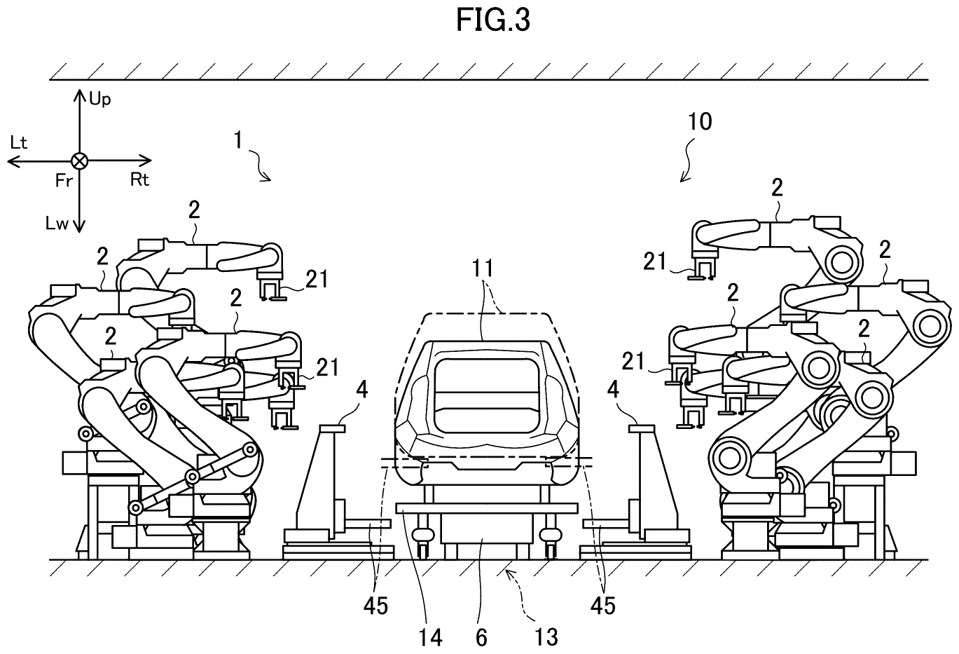

FIG. 1 is a diagram illustrating part of an automobile manufacturing factory where a robot system 1 is applied. FIG. 2 is an example of a work area 13 where work is performed on a workpiece in the manufacturing factory. FIG. 3 is the work area 13 viewed from a different angle than FIG. 2.

A manufacturing line 10 is provided in a building 12 of the manufacturing factory. The inside of the building 12 is an example of a specific area. The manufacturing line 10 in the illustrated example is a welding line, more specifically, a line for spot-welding a body 11 of an automobile. The workpiece is the body 11.

A robot system 1 is constructed on the manufacturing line 10. The robot system 1 includes an autonomous mobile robot (AMR) 6, which will be described later. The AMR 6 transports the body 11 on the manufacturing line 10. The work area 13 refers to an area where the workpiece transported by the AMR 6 stays and undergoes work. The work area 13 is part of the manufacturing line 10. The manufacturing line 10 of the illustrated example has a first work area 131 and a second work area 132. The first work area 131 is located relatively upstream in the traveling direction of the AMR 6, and the second work area 132 is located relatively downstream in the traveling direction of the AMR 6. The number of work areas 13 included in the manufacturing line 10 is not limited to a specific number.

The front side Fr, the rear side Rr, the right side Rt, the left side Lt, the upper side Up, and the lower side Lw of the robot system 1 are defined as follows with reference to the body 11 which is a work target in the work area 13.

The front side Fr of the robot system 1 is a rear left side in a direction connecting a front right side and a rear left side of the paper of FIG. 2. The front side Fr of the robot system 1 corresponds to the front side of the body 11 of the automobile, and the rear side Rr of the robot system 1 corresponds to the rear side of the body 11 of the automobile. As described later, a front-rear direction corresponds to a transport direction of the body 11.

The right side Rt of the robot system 1 is the right rear side in a direction connecting the left front side and the right rear side of the paper of FIG. 2. The right side Rt of the robot system 1 corresponds to the right side of the body 11 of the automobile. The left side Lt of the robot system 1 corresponds to the left side of the body 11 of the automobile. A left-right direction is a direction horizontally orthogonal to the front-rear direction.

The upper side Up of the robot system 1 is the top side of the paper of FIG. 2, and the lower side Lw of the robot system 1 is the bottom side of the paper. The upper and lower sides of the robot system 1 correspond to the upper and lower sides of the body 11 of the automobile. An up-down direction is a direction orthogonal to the front-rear direction.

The above definitions are used to describe the robot system 1, and are not used to limit the structure or configuration of the robot system 1 disclosed herein and components of the robot system 1.

As shown in FIG. 2 or 3, robots 2 and 4 are placed in the work area 13. The robots 2 and 4 perform spot welding on the body 11 in the work area 13.

The robot 2 is a work robot 2 that performs work on the workpiece transported to the work area 13. The work that the work robot 2 performs on the body 11 is welding.

The work robot 2 is a vertically articulated robot having five to seven axes. As shown in FIG. 3, the work robot 2 has a welding gun 21 as an end effector. The work robot 2 is not limited to the vertically articulated robot.

Two or more work robots 2 are placed in the work area 13. The work robots 2 are located on the left and right sides of the body 11 of the automobile to sandwich the body 11. The work robots 2 on the right side of the body 11 are arranged in the front-rear direction of the body 11. Likewise, the work robots 2 on the left side of the body 11 are arranged in the front-rear direction of the body 11. The work robots 2 perform welding at different parts of the body 11. Any number of work robots 2 may be used without limitation. The work robots 2 may be placed anywhere without limitation.

The robot 4 is a locator 4 that serves as a support robot. Two or more locators 4 are placed in the work area 13. The locators 4 are placed on the left and right sides of the body 11. The locators 4 are placed between the work robots 2 and the AMR 6. The relative arrangement of the work robots 2, the locators 4, and the AMR 6 in the work area 13 is not limited to the example shown in FIG. 3.

As indicated by a dot-dash line in FIG. 3, the locators 4 lift and support the body 11 while the work robots 2 are at work. The locators 4 in the illustrated example are three-axis orthogonal robots. Each locator 4 has a rod 45 that engages with the body 11. The rod 45 extends in the horizontal direction. A tip end of the rod 45 engages with the body 11. The locator 4 changes the position of the tip end of the rod 45 in the front-rear direction, the right-left direction, and the up-down direction. The structure of the locator 4 will be described later.

The robot system 1 includes one or more AMRs 6. The AMR 6 transports the workpiece to the work area 13. The AMR 6 travels on a flat floor surface in the factory. A route 15 of the AMR 6 is not preset, but is roughly determined as indicated by a two-dot-dash line in FIG. 1.

As shown in FIG. 3, the body 11 is placed on a carriage 14. The AMR 6 is located below the carriage 14 and engages with the carriage 14. The AMR 6 transports the body 11 via the carriage 14. The AMR 6 may directly support the body 11 without the carriage 14. The AMR 6 has a substantially flat top surface and is short enough to be located under the carriage 14. The appearance of the AMR 6 shown in FIG. 2 or 3 is an example. The structure of the AMR 6 will be described later.

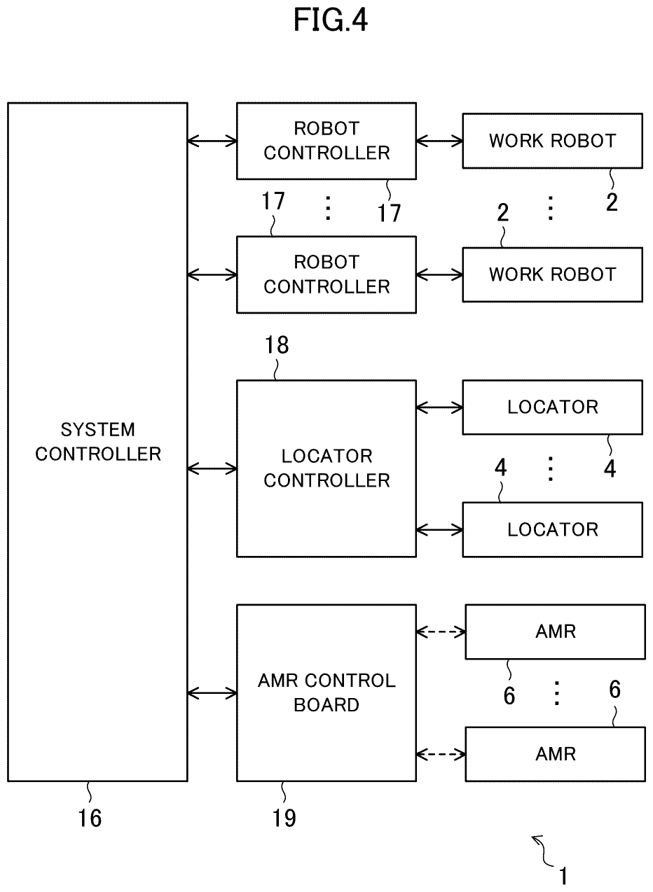

FIG. 4 is a block diagram of the robot system 1. The robot system 1 includes a system controller 16. The system controller 16 controls the entire robot system 1. The system controller 16 is not an essential component of the robot system 1.

The robot system 1 includes robot controllers 17. The robot controllers 17 are not essential components of the robot system 1. The robot controllers 17 are electrically connected to the system controller 16. The electrical connection includes wired or wireless connection. The robot controllers 17 are also electrically connected to the work robots 2. The robot controllers 17 and the work robots 2 are connected on a one-on-one basis. The robot system 1 includes the same number of robot controllers 17 as the work robots 2. A single robot controller 17 may be connected to the work robots 2.

Each robot controller 17 controls the work robot 2. More specifically, the robot controller 17 receives a control signal from the system controller 16 and outputs a control signal to the work robot 2. The work robot 2 receives the control signal from the robot controller 17 and performs welding on the body 11.

The robot system 1 includes a locator controller 18. The locator controller 18 is not an essential component of the robot system 1. The locator controller 18 is electrically connected to the system controller 16. The electrical connection includes wired or wireless connection. The locator controller 18 is also electrically connected to the locators 4.

The locator controller 18 controls the locators 4. More specifically, the locator controller 18 receives a control signal from the system controller 16 and outputs a control signal to the locators 4. When receiving the control signal from the locator controller 18, the locators 4 locate and support the body 11 delivered by the AMR 6 in a predetermined position.

The robot system 1 includes an AMR control board 19. The AMR control board 19 is not an essential component of the robot system 1. The AMR control board 19 is electrically connected to the system controller 16. The electrical connection includes wired or wireless connection. The AMR control board 19 is also electrically connected to the one or more AMRs 6.

The AMR control board 19 controls the AMR 6. More specifically, the AMR control board 19 receives a control signal from the system controller 16 and outputs a control signal to the AMR 6.

### (Structure of AMR)

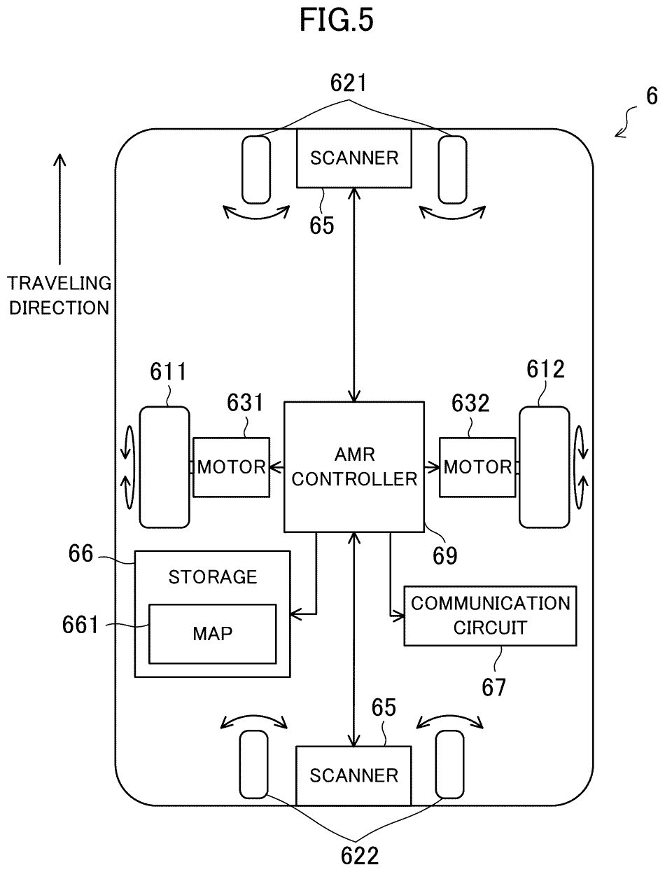

FIG. 5 shows the structure of the AMR 6. The structure of the AMR 6 in FIG. 5 is an example of the AMR 6.

The AMR 6 has wheels that roll on the floor surface. The wheels include two driving wheels 611 and 612, a driven wheel 621, and a driven wheel 622.

The two driving wheels 611, 612 are independent. The AMR 6 is an independently driven transport vehicle. The driving wheel 611 is located on the left of a middle portion of the AMR 6 in the front-rear direction. The driving wheel 612 is located on the right of the middle portion of the AMR 6. The driving wheels 611 and 612 have rotation axes that extend in the left-right direction and are coaxial.

The driving wheel 611 is mechanically connected to a motor 631. The driving wheel 612 is mechanically connected to a motor 632. The driving wheels 611 and 612 can rotate independently of each other.

The motors 631 and 632 are driven by electric power supplied from a battery. The battery is mounted on the AMR 6. The motors 631 and 632 are drive sources of the AMR 6. The driving force of the motors 631 and 632 is transmitted to the driving wheels 611 and 612 to rotate the driving wheels 611 and 612.

When the driving wheels 611 and 612 rotate in the same direction at the same rotational speed, the AMR 6 moves straight. When the driving wheels 611 and 612 rotate in the same direction at different rotational speeds, the AMR 6 changes the traveling direction. When the driving wheels 611 and 612 rotate in different directions, the AMR 6 turns on the spot, that is, rotates around the vertical axis.

The driven wheel 621 is located at a center portion of a front end of the AMR 6 in the left-right direction. The driven wheel 622 is located at a center portion of a rear end of the AMR 6 in the left-right direction. The driven wheels 621 and 622 can change their orientations. The AMR 6 may have a single driven wheel.

The AMR 6 includes scanners 65. Each scanner 65 acquires information on the surroundings of the AMR 6. The scanner 65 is an example of a sensor. The scanner 65 includes, for example, a light detection and ranging (LiDAR) device. The scanner 65 is not limited to the LiDAR device. The scanners 65 are located at the front and rear ends of the AMR 6, respectively.

The AMR 6 includes a storage 66. The storage 66 stores various data. The storage 66 stores a map 661 as the data. The map 661 is a plan of the inside of the building 12 including the manufacturing line 10. The AMR 6 autonomously travels in the building 12 in advance before transporting the body 11 and creates the map 661 using the scanners 65 while traveling.

The AMR 6 includes a communication circuit 67. The communication circuit 67 performs wireless communication with the AMR control board 19. The communication circuit 67 can receive a control signal from the AMR control board 19. The communication circuit 67 can transmit, for example, positional information of the AMR 6 to the AMR control board 19.

The AMR 6 has an AMR controller 69. The AMR controller 69 controls the AMR 6. The AMR controller 69 is electrically connected to the motors 631 and 632, the scanners 65, the storage 66, and the communication circuit 67.

During creation of the map 661, the AMR controller 69 outputs a control signal to the motors 631 and 632 to cause the AMR 6 to travel and creates the map 661 based on the signals from the scanners 65. The AMR controller 69 stores the created map 661 in the storage 66.

The AMR controller 69 receives a control signal from the system controller 16 through the AMR control board 19 and the communication circuit 67 and causes the AMR 6 to perform an operation according to the received control signal. The AMR 6 travels to a point designated by the system controller 16, that is, the work area 13 of the work robot 2. While the AMR 6 travels, the AMR controller 69 sets the route 15 of the AMR 6 based on the map 661. The AMR controller 69 estimates the position of the AMR 6 based on the signals from the scanners 65 and the map 661 while the AMR 6 is traveling. The AMR 6 autonomously travels to the work area 13 along the route 15 to transport the body 11 to the work area 13.

### (Structure of Locator)

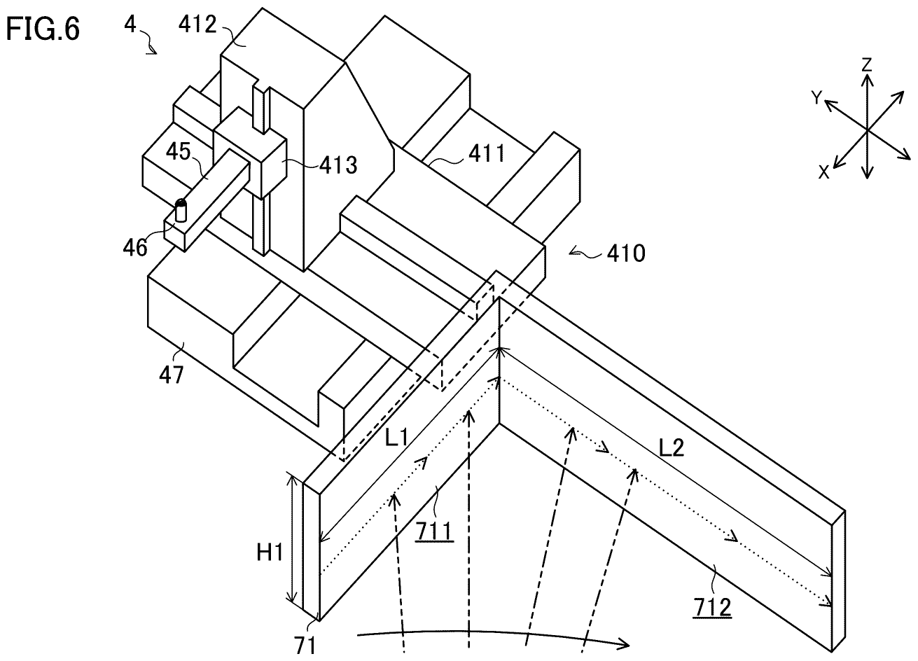

FIG. 6 is a perspective view of the locator 4. For the description of the locator 4, the directions of X-, Y-, and Z-axes are defined as follows. The X-axis is a horizontal axis and corresponds to the left-right direction of the robot system 1 when the locator 4 is placed in the work area 13. The Y-axis is a horizontal axis orthogonal to the X-axis. The Y-axis corresponds to the front-rear direction of the robot system 1 when the locator 4 is placed in the work area 13. The Z-axis is a vertical axis orthogonal to the X- and Y-axes. The Z-axis corresponds to the up-down direction of the robot system 1 when the locator 4 is placed in the work area 13.

As described above, the locator 4 is a three-axis orthogonal robot. The rod 45 of the locator 4 supports the body 11 from below. The rod 45 extends in the X-axis direction.

The locator 4 has an engaging part 46. The engaging part 46 is located at the tip end of the rod 45. The engaging part 46 engages with the body 11.

The locator 4 has a base 47. The base 47 is fixed to the floor surface. The locator 4 has a displacement mechanism 410. The displacement mechanism 410 displaces the rod 45 in the X-, Y-, and Z-axis directions. The displacement mechanism 410 includes a first stage 411, a second stage 412, and a third stage 413. The first stage 411 moves in the X-axis direction relative to the base 47. The second stage 412 moves in the Y-axis direction relative to the first stage 411. The third stage 413 moves in the Z-axis direction relative to the second stage 412.

The locators 4 support the body 11 delivered by the AMR 6. More specifically, after the AMR 6 stops in the work area 13, each of the locators 4 adjusts the position of the rod 45 in a horizontal plane to cause the engaging part 46 to engage with the body 11. Thereafter, the locators 4 synchronously raise the rods 45 to lift the body 11 to a welding position. The body 11 is separated upward from the carriage 14 when the welding is performed on the body 11. After the work robot 2 finishes the work, the locators 4 deliver the body 11 to the AMR 6. More specifically, the locators 4 synchronously lower the rods 45 so that the body 11 moves down from the welding position to the position where the body 11 is placed on the carriage 14. On completion of the delivery of the body 11 to the carriage 14, each of the locators 4 moves the rod 45 to the initial position and stops.

### (Map Creation by AMR)

As described above, the AMR 6 autonomously travels in the building 12 and creates the map 661 while traveling, using the scanners 65. The scanners 65 detect, for example, walls 121, 122, 123, 124, and 125 of the building 12. The walls 121, 122, 123, 124, and 125 are included in the map 661. The walls 121, 122, 123, 124, and 125 indicate the boundaries of the area where the AMR 6 can travel. The AMR 6 detects the walls 121, 122, 123, 124, and 125 by the scanners 65 while autonomously traveling to transport the body 11, and estimates its own position by comparing the positions of the detected walls 121, 122, 123, 124, and 125 with the map 661.

In many cases, the work robots 2 and the locators 4 are already placed in the work area 13 when the AMR 6 creates the map 661. However, conditions for the AMR controller 69 to determine that the work robots 2 and the locators 4 detected by the scanners 65 are walls on the map 661 may not be satisfied; or even if the work robots 2 and the locators 4 are included as the walls on the map 661, the work robots 2 or the locators 4 may move during the transport of the body 11, so that the positions of the work robots 2 or the locators 4 detected by the scanners 65 may differ from the positions of the work robots 2 or the locators 4 on the map 661. Thus, the work robots 2 and the locators 4 are not likely to be used for the localization of the AMR 6. In other cases, the work robots 2 and the locators 4 are not placed in the work area 13 when the AMR 6 creates the map 661. The work robots 2 and the locators 4 are not included in the map 661. The map 661 without the work robots 2 and the locators 4 eliminates the need of recreating the map 661 even if the positions of the work robot 2 and the locator 4 change and therefore advantageously allows more flexible arrangement of the work robots 2 and the locators 4.

When the AMR 6 transports the body 11, the work robots 2 or the locators 4 placed in the work area 13 are located between the AMR 6 and the walls 121, 122, 123, 124, and 125. The work robots 2 or the locators 4 may block the light emitted from the scanners 65 of the AMR 6, making it impossible or difficult for the scanners 65 to detect the walls 121, 122, 123, 124, and 125. If the scanners 65 fail to detect the walls 121, 122, 123, 124, and 125, the localization of the AMR 6 may decrease in accuracy. The AMR 6 is particularly required to stop at a precise position in the work area 13. This is because the body 11 is required to be precisely positioned with respect to the work robots 2 or the locators 4. High accuracy is required for the localization of the AMR 6 in the work area 13. However, as shown in FIG. 2 or 3, the multiple work robots 2 or locators 4 are placed in the work area 13, which makes it difficult for the scanners 65 to detect the walls 121, 122, 123, 124, and 125.

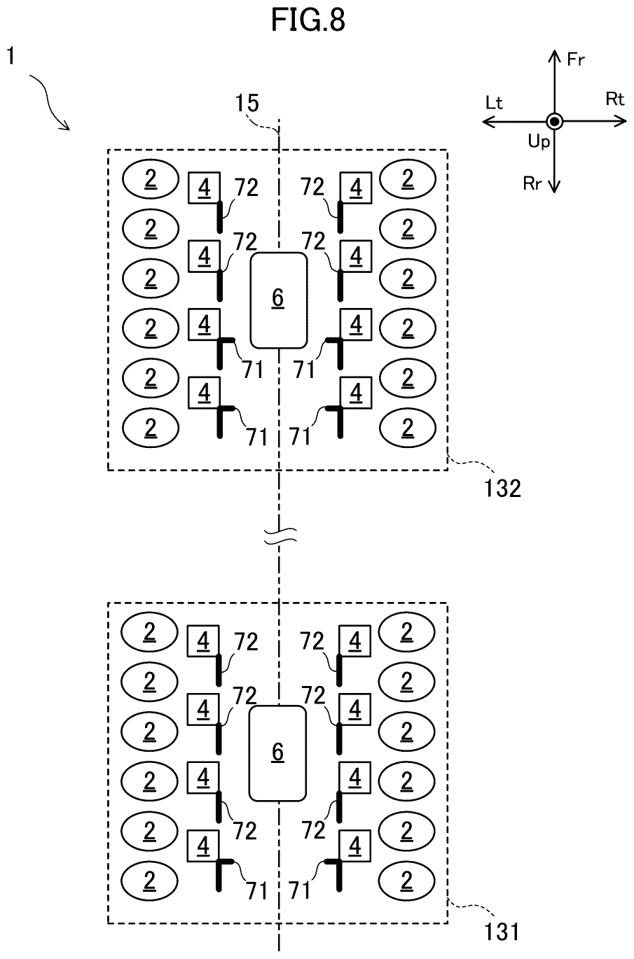

One of the features of the robot system 1 disclosed herein is the creation of the map 661 by the AMR 6 for improved accuracy of the localization of the AMR 6. Specifically, as shown in FIG. 8, objects 71 and 72 included as the walls in the map 661 are located in the work area 13 between the AMR 6 and a line of the work robots 2 and the locators 4. In FIG. 8, for easier understanding, the shapes of the work robots 2 and the locators 4 are simplified.

FIG. 6 shows a first object 71. The first object 71 is mounted on the locator 4. In the example of FIG. 6, the first object 71 is mounted on the first stage 411. The first object 71 moves in the X-axis direction as the first stage 411 is displaced in the X-axis direction. The first object 71 is not limited to being mounted on the first stage 411. The first object 71 may be mounted on the second stage 412 that is displaced in the horizontal direction. The first object 71 may be mounted on the base 47 so as not to move even when the rod 45 moves.

The first object 71 is formed of a plate, for example. The first object 71 has surfaces 711 and 712 that reflect light from the scanners 65. The surfaces 711 and 712 are not ones that are difficult to reflect light from (e.g., mat black surfaces). The surfaces 711 and 712 are not transparent. Both of the surfaces 711 and 712 are flat surfaces. The surfaces 711 and 712 are not limited to flat surfaces.

The surfaces 711 and 712 are sized so that they are recognized as walls by the AMR 6. More specifically, the surface 711 has a first height H1 and a first length L1, and the surface 712 has a first height H1 and a second length L2. The first height H1 may be, for example, 0.2 m or more. If the first height H1 is too high, the surfaces 711 and 712 may interfere with the locator 4 or the carriage 14. The first height H1 may be set based on the height of the AMR 6. Each of the first length L1 and the second length L2 may be, for example, 0.4 m or more.

The surfaces 711 and 712 intersect with each other. The surfaces 711 and 712 are at different angles when viewed from the AMR 6. The angle viewed from the AMR 6 is an angle with respect to the light emitted from the AMR 6. The surface 711 extends in the X-axis direction, and the surface 712 extends in the Y-axis direction. The surfaces 711 and 712 are orthogonal to each other. More precisely, the surfaces 711 and 712 are orthogonal to each other so as to be recessed with respect to the AMR 6. The first object 71 is L-shaped when viewed from above. The scanning light of the scanner 65 indicated by two-dot-dash line arrows in FIG. 6 is emitted to both of the surfaces 711 and 712 as indicated by arrows in dotted line. The scanner 65 detects the first object 71 by observing the light reflected from the surfaces 711 and 712. The scanner 65 easily detects the first object 71 having the surfaces 711 and 712 intersecting with each other.

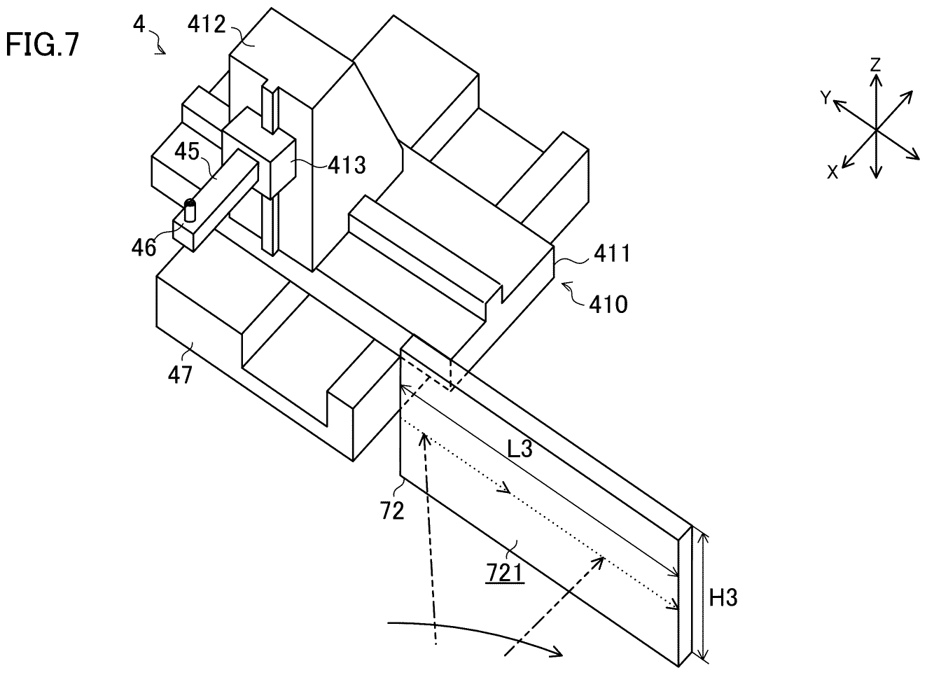

FIG. 7 shows a second object 72. The second object 72 is mounted on the locator 4. In the example of FIG. 7, the second object 72 is mounted on the first stage 411. The second object 72 moves in the X-axis direction as the first stage 411 is displaced in the X-axis direction. The second object 72 is not limited to being mounted on the first stage 411. The second object 72 may be mounted on the second stage 412 that is displaced in the horizontal direction. The second object 72 may be mounted on the base 47 so as not to move even when the rod 45 moves.

The second object 72 is formed of a plate, for example. The second object 72 has a surface 721 that reflects light from the scanners 65. The surface 721 is not one that is difficult to reflect light from (e.g., a mat black surface). The surface 721 is not transparent. The surface 721 is a flat surface. The surface 721 is not limited to a flat surface. The surface 721 extends in the Y-axis direction. The second object 72 is I-shaped in contrast to the L-shaped first object 71.

The surface 721 is sized so that it is recognized as a wall by the AMR 6. More specifically, the surface 721 has a third height H3 and a third length L3. The third height H3 may be, for example, 0.2 m or more. The third height H3 may be set based on the height of the AMR 6. The third length L3 may be, for example, 0.4 m or more.

FIG. 8 shows an example arrangement of the objects 71 and 72 in the first work area 131 and the second work area 132. The work robots 2 and the locators 4 are located on each side of the AMR 6 in the left-right direction. The objects 71 and 72 are mounted on the locators 4 on the right side of the AMR 6. The objects 71 and 72 are also mounted on the locators 4 on the left side of the AMR 6. The objects 71 and 72 are located between the work robots 2 and the AMR 6 in the work area 131 or 132. The objects 71 and 72 do not overlap the locators 4 when viewed from the AMR 6. The light emitted by the scanners 65 toward the objects 71 and 72 is not blocked by the locators 4.

In the first work area 131, the objects 71 and 72 are in line symmetry with respect to a center line extending in the front-rear direction of the first work area 131. In the second work area 132, the objects 71 and 72 are in line symmetry with respect to a center line extending in the front-rear direction of the second work area 132. The objects 71 and 72 in the first work area 131 are not limited to the line symmetry arrangement. The objects 71 and 72 in the second work area 132 are also not limited to the line symmetry arrangement.

The objects 71 and 72 in the first work area 131 and the objects 71 and 72 in the second work area 132 are arranged differently. Specifically, in the first work area 131, the L-shaped first objects 71 are mounted on the rearmost locators 4 among the locators 4 arranged in the front-rear direction. The I-shaped second objects 72 are mounted on the remaining locators 4. In the second work area 132, the L-shaped first objects 71 are mounted on the rearmost locators 4 and the second rearmost locators 4, among the locators 4 arranged in the front-rear direction. The I-shaped second objects 72 are mounted on the remaining locators 4. The arrangement of the objects 71 and 72 in the first work area 131 shown in FIG. 8 is an example, and the arrangement of the objects 71 and 72 in the second work area 132 is also an example.

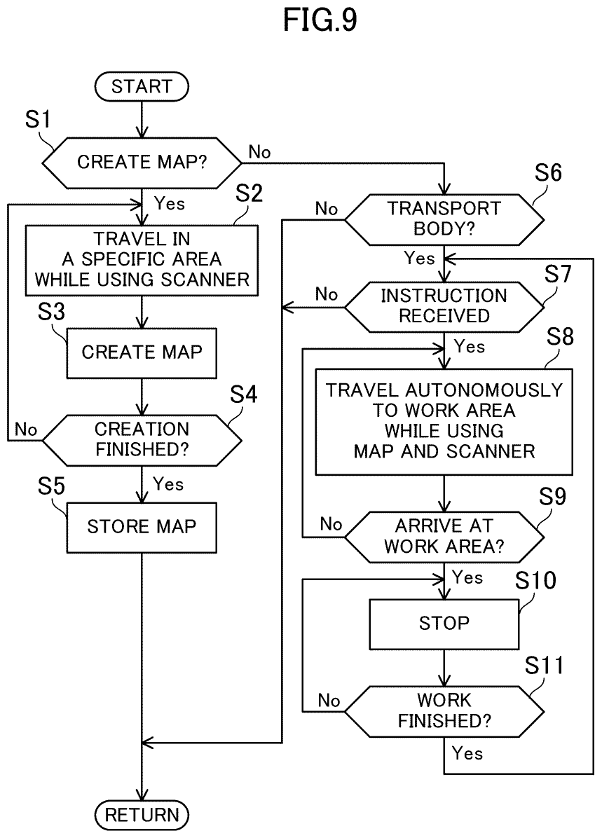

Next, a process of creating the map 661 by the AMR 6 and a process of transporting the body 11 using the map 661 and the scanners 65 will be described below. FIG. 9 is a flowchart of the control of the AMR 6. Steps S1 to S5 in the flowchart of FIG. 9 are related to the creation of the map 661 by the AMR 6. First, in Step S1, the AMR controller 69 determines whether to create the map 661. In the case of creating the map 661, the process of FIG. 9 proceeds to Step S2. In Step S2, the AMR controller 69 travels in a specific area, that is, in the building 12 of the factory, while using the scanners 65. In the subsequent Step S3, the AMR controller 69 creates the map 661 based on the detection by the scanners 65. At least the locators 4 having the objects 71 and 72 are located in the work area 13 when the map 661 is created. The scanners 65 detect the objects 71 and 72, and the AMR controller 69 recognizes the detected objects 71 and 72 as walls. The objects 71 and 72 are included in the map 661. In Step S4, the AMR controller 69 determines whether the creation of the map 661 is finished. If the creation is not finished, the AMR controller 69 repeats Steps S2 and S3. When the creation of the map 661 is finished, the AMR controller 69 stores the map 661 created in Step S5 in the storage 66.

Steps S6 to S11 in the flowchart of FIG. 9 are related to the transport of the body 11 using the created map 661. If the AMR controller 69 selects NO in Step S1, the AMR controller 69 determines whether to transport the body 11 in Step S6. In the case of not transporting the body 11, the process of FIG. 9 returns to Step S1. In the case of transporting the body 11, the AMR controller 69 determines whether an instruction from the system controller 16 is received in Step S7. If no instruction is received, the process of FIG. 9 returns to Step S1. If the instruction is received, the AMR controller 69 autonomously travels to the instructed work area 13 using the map 661 and the scanners 65 in Step S8. While the AMR 6 is autonomously traveling to transport the body 11, the locators 4 having the objects 71 and 72 are positioned in the work area 13. The scanners 65 detect the objects 71 and 72, and the AMR controller 69 estimates its own position by collating the detected objects 71 and 72 with the map 661.

In Step S9, the AMR controller 69 determines whether the AMR 6 has arrived at the work area 13. The AMR 6 keeps traveling autonomously until the AMR 6 arrives at the work area 13 (see Step S8). When the AMR 6 arrives at the work area 13, the AMR 6 stops at a predetermined position in the work area 13 in Step S10. The body 11 is delivered from the AMR 6 to the locators 4.

In Step S11, the AMR controller 69 determines whether the work robot 2 has finished its work. The AMR 6 remains stopped until the work is finished. When the work is finished, the process of FIG. 9 returns to Step S7. The AMR controller 69 determines whether the next instruction is received, and repeats Steps S8 to S11 if the instruction is received. If no instruction is received, the process of FIG. 9 returns to Step S1.

### Effects and Advantages

The AMR 6 requires no traveling guide. As shown in FIG. 2 or 3, the manufacturing line 10 including the AMR 6 advantageously eliminates a pit that is required in the conventional manufacturing line to build a rail for transporting the body and a lift for the body. The flat floor surface in the factory advantageously allows easy layout changes of the manufacturing line 10 having the AMR 6.

Use of the AMR 6 on the manufacturing line 10 enables production adjustment by adjusting the number of AMRs 6. This allows flexible operation of the manufacturing line 10.

When the AMR 6 creates the map 661, the objects 71 and 72 are mounted on the locators 4 placed in the work area 13. The scanners 65 of the AMR 6 detect the objects 71 and 72 in addition to the walls 121, 122, 123, 124, and 125. The AMR controller 69 includes the objects 71 and 72 as walls in the map 661 in addition to the detected walls 121, 122, 123, 124, and 125. The robot system 1 can include the objects 71 and 72 in the map 661.

Also when the AMR 6 transports the body 11, the objects 71 and 72 are mounted on the locators 4 placed in the work area 13. The scanners 65 of the AMR 6 detect the objects 71 and 72 in addition to the walls 121, 122, 123, 124, and 125. The AMR controller 69 estimates the position of the AMR 6 by collating the positions of the detected walls 121, 122, 123, 124, and 125 and the objects 71 and 72 with the map 661. The objects 71 and 72 are located between the work robots 2 and the AMR 6 as shown in FIG. 8, allowing the light from the scanners 65 to reach the objects 71 and 72 even if the light from the scanners 65 is blocked by the work robots 2 and does not reach the walls 121, 122, 123, 124, and 125. The scanners 65 can stably detect the objects 71 and 72. Stable detection of the objects 71 and 72 included in the map 661 allows the localization of the AMR 6 with high accuracy.

The objects 71 and 72 are mounted on the robot. More specifically, the objects 71 and 72 are mounted on the locators 4. The objects 71 and 72 change their positions when the locators 4 are operated. Until the AMR 6 reaches the work area 13 and stops there, the locators 4 do not support the body 11, and the rods 45 of the locators 4 are at their initial positions. The positions of the objects 71 and 72 correspond to the initial positions of the rods 45. The positions of the objects 71 and 72 detected by the scanners 65 during the map creation by the AMR 6 and the transport of the body 11 by the AMR 6 correspond to the initial positions. Thus, the positions of the detected objects 71 and 72 can be used for the localization of the AMR 6 by collating the positions with the map 661. Mounting the objects 71 and 72 on the locators 4 can reduce the distance between the AMR 6 and the locators 4, which contributes to the downsizing of the work area 13.

The objects 71 and 72 are located on the left and right sides of the AMR 6 in the work area 13. Having a large number of objects 71 and 72 allows the localization of the AMR 6 with high accuracy. The first object 71 is L-shaped. The L-shaped first object 71 having the surfaces 711 and 712 is stably detected by the scanners 65. The L-shaped first object 71 advantageously improves the accuracy of the localization of the AMR 6. The objects 71 and 72 having the surfaces 711, 712, and 721 that reflect light can be stably detected by the scanners 65.

The objects 71 and 72 in the first work area 131 and the objects 71 and 72 in the second work area 132 are arranged differently; therefore, the AMR 6 can distinguish the first work area 131 and the second work area 132 based on the detected objects 71 and 72. As shown in FIG. 1, particularly for the manufacturing line 10 where multiple work areas 13 are arranged, distinguishing the work areas 13 advantageously improves the accuracy of the localization of the AMR 6.

### Variations

The objects 71 and 72 may be mounted on the work robots 2 instead of being mounted on the locators 4. The objects 71 and 72 may be mounted on both the locators 4 and the work robots 2. The objects 71 and 72 may be arranged between the locators 4 and the AMR 6 instead of being mounted on the locators 4.

The shapes of the objects 71 and 72 are not limited to those shown in FIG. 6 or 7. The objects 71 and 72 may have any shape. The surface 711 may be angled with respect to the X-axis, and the surface 712 may be angled with respect to the Y-axis. The surface 721 may be angled with respect to the Y-axis.

The objects 71 and 72 are not limited to being mounted on all the locators 4. The objects 71 and 72 may be mounted on some of the locators 4 in the work area 13.

The number of objects 71 and 72 in the first work area 131 can differ from the number of objects 71 and 72 in the second work area 132.

As an alternative to or in addition to the locators 4, the robot system 1 may include an articulated robot that supports the body 11. That is, the support robot is not limited to the three-axis orthogonal robot. The objects 71 and 72 may be mounted on an articulated robot that supports the body 11. The locator 4, which is a three-axis orthogonal robot, is relatively small. The locators 4 placed between the AMR 6 and the work robots 2 are less likely to interfere with the work robots 2, and the work area 13 can be advantageously small in size by reducing the distance between the locators 4 and the work robots 2.

The robot system 1 may have no system controller 16. The robot system 1 may perform the welding on the body 11 by mutual communication of the robot controller 17, the locator controller 18, and the AMR control board 19.

The work performed by the robot system 1 disclosed herein on the manufacturing line 10 is not limited to the welding. The workpiece to be handled by the robot system 1 is not limited to the body 11 of the automobile. The robot system 1 is not limited to the application to the automobile manufacturing line 10.

The functionality of the elements disclosed herein may be implemented using one or more circuitry or processing circuitry which includes general purpose processors, special purpose processors, integrated circuits, ASICs (“Application Specific Integrated Circuits”), FPGAs (“Field Programmable Gate Arrays”) and/or conventional circuitry. The functionality of the elements disclosed herein may be implemented using one or more circuitry or processing circuitry which includes combinations of general purpose processors, special purpose processors, integrated circuits, ASICs, FPGAs, or conventional circuitry. The one or more circuitry or processing circuitry is programmed, using one or more programs stored together or individually in one or more memories, or otherwise configured to perform the disclosed functionality. Processors are considered processing circuitry or circuitry as they include transistors and other circuitry therein. The processor may be a programmed processor which executes a program stored in a memory. In the disclosure, the circuitry, units, or means are hardware that carry out or are programmed to perform the recited functionality, alone or in combination with one another. The hardware may be any hardware disclosed herein which is programmed or configured to carry out the recited functionality.

There is a memory that stores a computer program which includes computer instructions. The computer instructions provide the logic and routines that enable the hardware to perform the method disclosed herein. The hardware includes, e.g., processing circuitry or circuitry. The computer program can be implemented in known formats as a computer-readable storage medium, a computer program product, a memory device, a record medium such as a CD-ROM or DVD, and/or the memory of a FPGAs or ASICs.

### ASPECTS

The above embodiments are specific examples of the following aspects.

### First Aspect

A robot system (1) including:
a robot (2, 4) placed in a work area (13) where work is performed on a workpiece (11);
a transport robot (6) that includes: a map (661) of a specific area including the work area (13); and a sensor (65) that detects surrounding conditions, the transport robot (6) transporting the workpiece (11) to the work area (13) by autonomously traveling in the specific area while estimating its own position using the map (661) and the sensor (65) and stopping in the work area (13) until the work on the workpiece (11) is finished; and
an object (71, 72) located between the robot (2, 4) and the transport robot (6) in the work area (13), the object (71, 72) being detected by the sensor (65) and included as a wall in the map (661) both when the transport robot (6) creates the map (661) of the specific area using the sensor (65) and when the transport robot (6) transports the workpiece (11) using the map (661) and the sensor (65).

The robot system (1) can include the object (71, 72) as a wall in the map (661) when the transport robot (6) creates the map (661). The object (71, 72) in the work area (13) is easily detected by the sensor (65); therefore, the robot system (1) can improve the accuracy of localization of the transport robot (6) by collating the position of the detected object (71, 72) with the map (661) at the transport of the workpiece (11).

### Second Aspect

In the robot system (1) of the first aspect, the object (71, 72) is mounted on the robot (2, 4).

Mounting the object (71, 72) on the robot (2, 4) allows effective use of the space of the work area (13). At the layout change for changing the location of the robot (2, 4), the object (71, 72) can be arranged at a position corresponding to the location of the robot (2, 4).

### Third Aspect

In the robot system (1) of the first or second aspect, a work robot (2) that performs work on the workpiece (11) and a support robot (4) that supports the workpiece (11) delivered by the transport robot (6) during the work of the work robot (2) are placed in the work area (13), and
the object (71, 72) is mounted on the support robot (4).

### Fourth Aspect

In the robot system (1) of the third aspect, the work robot (2) is located laterally relative to the transport robot (6), in a first direction orthogonal to a traveling direction of the transport robot (6) in the work area (13), and
the support robot (4) is located between the work robot (2) and the transport robot (6).

Since the support robot (4) is located between the work robot (2) and the transport robot (6), the support robot (4) and the work robot (2) can be efficiently arranged in the work area (13) while avoiding the interference between the support robot (4) and the work robot (2).

Since the object (71, 72) is mounted on the support robot (4), the sensor (65) of the transport robot (6) can stably detect the object (71, 72) without being blocked by the work robot (2). The stable detection of the object (71, 72) can increase the accuracy of the localization of the transport robot (6).

### Fifth Aspect

In the robot system (1) of the third or fourth aspect, the work robot (2) and the support robot (4) are located on each of a first side and a second side of the transport robot (6) in the first direction, and
the object (71, 72) is mounted on the support robot (4) on the first side and the support robot (4) on the second side.

Providing the objects (71, 72) on the first and second sides of the transport robot (6) leads to an increase in the number of objects (71, 72) detected by the sensor (65). The increased number of objects (71, 72) increases the accuracy of the localization of the transport robot (6).

### Sixth Aspect

In the robot system (1) of any one of the third to fifth aspects, the support robot (4) is a three-axis orthogonal robot.

Since the three-axis orthogonal robot is relatively small, the support robot (4) and the work robot (2) can be efficiently arranged in the work area (13) while avoiding the interference between the support robot (4) and the work robot (2). The efficient arrangement of the support robot (4) and the work robot (2) reduces the distance between the support robot (4) and the work robot (2), making it difficult for the sensor (65) to detect the wall. The object (71, 72) arranged in the work area (13) enables high-accuracy localization of the transport robot (6).

### Seventh Aspect

In the robot system (1) of any one of the first to sixth aspects, the sensor (65) is a LiDAR (Light Detection And Ranging) sensor, and
the object (71, 72) has a surface (711, 712, 721) that reflects light.

The surface (711, 712, 721) of the object (71, 72) that reflects light emitted by the LiDAR sensor is advantageous for stable detection of the object (71, 72) by the sensor (65).

### Eighth Aspect

In the robot system (1) of the seventh aspect, the first object (71) has a first surface (711) and a second surface (712), and
the first surface (711) and the second surface (712) are at different angles when viewed from the transport robot (6).

The sensor (65) can stably detect the first object (71) having the first surface (711) and the second surface (712) arranged at different angles. The first object (71) increases the accuracy of the localization of the transport robot (6).

### Ninth Aspect

In the robot system (1) of any one of the first to eighth aspects, the work area (13) includes a first work area (131) and a second work area (132), and
the object (71, 72) in the first work area (131) and the object (71, 72) in the second work area (132) are arranged differently.

With a different arrangement between the object (71, 72) in the first work area (131) and the object (71, 72) in the second work area (132), the transport robot (6) can distinguish between the first work area (131) and the second work area (132) based on the detected arrangements of the objects (71, 72). This configuration is advantageous for the increase in the accuracy of the localization of the transport robot (6).

### Tenth Aspect

In the robot system (1) of any one of the first to ninth aspects, the object (71, 72) includes a first object (71) and a second object (72) with a different shape from the first object (71).

Arranging a combination of the first object (71) and the second object (72) with different shapes in the work area (13) enables high-accuracy localization of the transport robot (6) based on the characteristic difference between the first object (71) and the second object (72) detected by the sensor (65).

### Eleventh Aspect

A method of transporting a workpiece (11) using a transport robot (6), the method comprising: causing the transport robot (6) to create a map (661) of a specific area including a work area (13) where a robot (2, 4) is placed and work is performed on the workpiece (11), using a sensor (65) that detects surrounding conditions;
causing the transport robot (6) to travel autonomously in the specific area while estimating its own position using the map (661) and the sensor (65) to transport the workpiece (11) to the work area (13); and
causing the transport robot (6) to stop in the work area (13) until the work on the workpiece (11) is finished, wherein
an object (71, 72) is located between the robot (2, 4) and the transport robot (6) in the work area (13), the object (71, 72) being detected by the sensor (65) and included as a wall in the map (661) both when the transport robot (6) creates the map (661) using the sensor (65) and when the transport robot (6) transports the workpiece (11) using the map (661) and the sensor (65).

Since the sensor (65) of the transport robot (6) detects the object (71, 72) in the work area (13) included as a wall in the map (661), the transport robot (6) can estimate its own position with high accuracy.

What is claimed is:

1. A robot system, comprising:
a robot placed in a work area where work is performed on a workpiece;
a transport robot that includes: a map of a specific area including the work area; and a sensor that detects surrounding conditions, the transport robot transporting the workpiece to the work area by autonomously traveling in the specific area while estimating its own position using the map and the sensor and stopping in the work area until the work on the workpiece is finished; and
an object located between the robot and the transport robot in the work area, the object being detected by the sensor and included as a wall in the map both when the transport robot creates the map of the specific area using the sensor and when the transport robot transports the workpiece using the map and the sensor.

2. The robot system of claim 1, wherein
the object is mounted on the robot.

3. The robot system of claim 2, wherein
a work robot that performs work on the workpiece and a support robot that supports the workpiece delivered by the transport robot during the work of the work robot are placed in the work area, and
the object is mounted on the support robot.

4. The robot system of claim 3, wherein
the work robot is located laterally relative to the transport robot, in a first direction orthogonal to a traveling direction of the transport robot in the work area, and
the support robot is located between the work robot and the transport robot.

5. The robot system of claim 4, wherein
the work robot and the support robot are located on each of a first side and a second side of the transport robot in the first direction, and
the object is mounted on the support robot on the first side and the support robot on the second side.

6. The robot system of claim 3, wherein
the support robot is a three-axis orthogonal robot.

7. The robot system of claim 1, wherein
the sensor is a light detection and ranging (LiDAR) sensor, and
the object has a surface that reflects light.

8. The robot system of claim 7, wherein
the object has a first surface and a second surface, and
the first surface and the second surface are at different angles when viewed from the transport robot.

9. The robot system of claim 1, wherein
the work area includes a first work area and a second work area, and
the object in the first work area and the object in the second work area are arranged differently.

10. The robot system of claim 1, wherein
the object includes a first object and a second object with a different shape from the first object.

11. A method of transporting a workpiece using a transport robot, the method comprising:
causing the transport robot to create a map of a specific area including a work area where a robot is placed and work is performed on a workpiece, using a sensor that detects surrounding conditions;
causing the transport robot to travel autonomously in the specific area while estimating its own position using the map and the sensor to transport the workpiece to the work area; and
causing the transport robot to stop in the work area until the work on the workpiece is finished, wherein
an object is located between the robot and the transport robot in the work area, the object being detected by the sensor and included as a wall in the map both when the transport robot creates the map using the sensor and when the transport robot transports the workpiece using the map and the sensor.
